(19) United States
(12) Patent Application Publication
(10) Pub. No.: US 2012/0133196 A1
(43) Pub. Date: May 31, 2012

(54) Use of Resist Coating to Enhance Adhesion of Wheel Claddings

(75) Inventors: Shaun Raney, Lancaster, KY (US); Douglas Cutcher, Bloomfield Hills, MI (US); Matthew Finelli, Royal Oak, MI (US); Michael Torakis, Gross Pointe, MI (US)

(73) Assignee: McKechnie Vehicle Components USA, Inc., Roseville, MI (US)

(21) Appl. No.: 13/382,569

(22) PCT Filed: Jul. 9, 2010
(86) PCT No.: PCT/US2010/041468

§ 371 Date: Feb. 13, 2012

Related U.S. Application Data
(60) Provisional application No. 61/224,595, filed on Jul. 10, 2009.

(51) Int. Cl. B60B 7/00; B32B 37/02; B60B 7/06; B32B 37/12

(52) U.S. Cl. 301/37.102; 156/278; 301/37.101; 301/37.42

(57) ABSTRACT

A method of securing wheel covers to the outboard surfaces of wheels to form wheel assemblies. The method involves applying resist coating patterns to portions or the entire inboard surfaces of the wheel covers prior to subjecting the wheel cover to a plating process which is intended to plate the outboard surfaces of the wheel covers. The resist coating pattern prevents plating material from attaching to areas of the inboard surfaces of the wheel covers to which the resist coat has been applied or which have been framed in or outlined by the resist coating. Areas that are coated with the resist and areas that have been framed in or outlined by the resist coating are more susceptible and compatible to adhesive bonding of the wheel covers to the wheels.

### FIELD OF THE INVENTION

The present invention relates to vehicle wheel assemblies that have decorative wheel covers secured to the outboard surface of wheels for aesthetic purposes. More specifically, the present invention relates to methods for adhesively securing decorative wheel covers to wheels, which methods involve the use of resist coatings.

### BACKGROUND

Wheel assemblies that utilize wheel appliques to decorate the external or outboard surfaces of plain aluminum and steel wheels are well known and are far less expensive to produce than decorative wheels that have to be formed and finished.

Many wheel assemblies include decorative wheel covers that are adhesively attached to underlying wheels. U.S. Pat. No. 3,669,501 to Derleth discloses the use of a foamable adhesive that is used to secure a decorative cover to a wheel. The decorative cover in Derleth is configured to have variations in contour in a direction transverse to the axis of the wheel which exceed the variations in the rim and/or disc contour of the wheel, which variations would be extremely difficult and expensive, if not impossible, to cast, stamp or draw in the disc of the wheel. During assembly, a foamable adhesive is coated on the wheel, and the decorative cover is then quickly clamped to the wheel before the adhesive begins to foam. As the adhesive foams, void spaces between the wheel and cover are filled with the foamable adhesive.

Turbine openings are a necessary element in today's wheel systems in providing proper cooling to brake systems. In addition, the aesthetics of endless configurations of turbine openings add individuality and style to a vehicle wheels. The inclusion of turbine openings in wheels and wheel covers creates problems with the use of adhesives. In order to use certain types of adhesives, it would be necessary to use some additional structure to seal large openings such as turbine openings to prevent the foamable adhesive from escaping through the opening rather than spread evenly or completely between a wheel and wheel cover.

U.S. Pat. Nos. 5,368,370 and 5,461,779 to Beam disclose an ornamental applique formed on a uniform thickness of stainless steel sheet stock that requires attachment to the wheel by the use of a full surface curable adhesive uniformly deposited between the stainless steel cover and a mechanical locking arrangement. The mechanical locking arrangement consists of an undercut in the rim of the wheel into which the cover nests and a hole in the wheel aligned with a hole in the applique wherein a lug stud is permanently attached to create a mechanical lock that, according to Beam's teachings, compresses the full surface uniform layer of curable adhesive to hold the applique in place until the adhesive cures.

Beam's teachings exemplify an early concern that adhesives used to secure wheel covers onto wheel assemblies had to be applied as continuous coatings between the wheel covers and wheels in order to secure the attachment and prevent moisture and dirt from entering any gaps between the wheel covers and wheels and causing corrosion to develop.

There are some restrictions on the types of adhesives that can be used to secure wheel covers to wheels and considerations on how to apply some adhesives. Suitable adhesives have to withstand the high temperatures generated by tires, wheels and braking systems. In the case of air-cured and moisture-cured adhesives, it has been discovered that the use of continuous coatings of the adhesives between wheel covers and a wheels adversely effects cure time.

U.S. Pat. No. 5,597,213 to Chase exemplifies the use beads of adhesive that are provide in parallel as separated lines of adhesive rather than a continuous layer to create voids so as to reduce the amount of curing time of the adhesive and thereby reduce manufacturing time and costs. In Chase, air between the lines of adhesives is captured between the overlay and the wheel to assist in curing the adhesive. In the case of adhesives that are moisture-cured, Chase proposes introducing high humidity air into the assembly process and the technique of selective application of the adhesive can be utilized to establish voids between lines of adhesive that serve to entrap moisture laden air further enhancing cure times and reducing overall costs of the manufacturing process.

U.S. Pat. No. 6,007,158 to Maloney et al. teaches a vehicle cover retention system and method for producing the same. Maloney et al. applies an adhesive in a pattern, which when pressed between the wheel cover and wheel can fill less that the entire gap between the wheel cover and wheel, but nevertheless is effective to prevent water, mud and debris from entering into any voids or gaps between the wheel cover and wheel. Adhesive patterns exemplified in FIG. 6 of Maloney et al. are designed to establish seals that prevent water, mud and debris from entering any voids, gaps or other spaces between the wheel covers and the wheels. The concern remains that if such water, mud and debris enter any voids, gaps or other spaces between the wheel covers and the wheels, it will eventually cause corrosion to occur between the wheel covers and wheel and result in detachment of the wheel cover or at an unsightly appearance.

U.S. Pat. No. 6,932,435 to Cutcher et al. discloses the use of adhesive patterns which are configured to allow ambient fluids to enter throughout the space between the decorative wheel cover and the wheel (and leave) which is not filled with the cured adhesive to prevent corrosion from occurring between the decorative wheel cover and wheel.

U.S. Pat. No. 7,025,426 to Hogan discloses sound dampening adhesive patterns that include primary adhesive patterns that are sufficient to secure the wheel covers to the wheels and an auxiliary adhesive pattern that include discrete portions that are provided in hollow portions defined by the primary adhesive patterns between the wheel covers and wheels. The discrete portions of the auxiliary adhesive patterns prevent the hollow portions from sounding hollow.

For chrome plated wheel covers, in order to properly plate all of the recessed surfaces on the outboard surface (for both appearance and performance reasons) chrome plating layers will also be present on the inboard surface of the wheel cover. Due to the smooth, hard and inorganic nature of the inboard plated surface (particularly a chrome plated surface), it is difficult to establish and maintain a robust adhesive bond when attempting to use conventional adhesives to secure a plated wheel cover to a wheel.

Presently, adhesive primers are utilized on inboard chrome plated surfaces of wheel covers to improve the adhesion between the adhesives and the chrome plated surfaces. The use of adhesive primers still involves challenges in bonding organic adhesive primers to the inorganic chrome plated surfaces.

The present invention provides a method for adhesively securing decorative wheel covers to wheels, which method involves the use of resist coatings that prevent plating metals from attaching to the inboard surface of the wheel covers.

### SUMMARY

According to various features, characteristics and embodiments of the present invention which will become apparent as the description thereof proceeds, the present invention provides a method of securing a wheel cover to a wheel to form a wheel assembly which method involves:

providing a wheel having an outboard surface;

providing a wheel cover having an inboard surface and an outboard surface;

applying a resist coating pattern to portions of the inboard surface of the wheel cover;

subjecting the wheel cover to a plating process which plates the outboard surface of the wheel cover and which does not plate the portions of the inboard surface of the wheel cover which are:
coated with the resist coating pattern or
framed in or outlined by the resist coating pattern;
applying an adhesive pattern to at least one of the outboard surface of the wheel or the inboard surface of the wheel cover, said adhesive pattern corresponding to at least:
a portion of the resist coating pattern or
an area of the inboard surface of the wheel cover that had been framed in or outlined by the resist coating pattern; and
securing the wheel cover to the wheel with the adhesive pattern.

The present invention further provides for a wheel cover for a motor vehicle wheel which includes:

a disc shaped member having an inboard surface and an outboard surface and which is contoured to be attached to an outboard surface of a vehicle wheel;

a metal plating layer on the outboard surface of the disc shaped member; and

a resist coating pattern on the inboard surface of the disc shaped member.

The present invention also provides a wheel assembly that includes:

a wheel having an outboard surface;

a wheel cover having an inboard surface and an outboard surface;

a resist coating on a portion of the inboard surface of the wheel cover; and

an adhesive layer securing the inboard surface of the wheel cover against the outboard surface of the wheel with at least a portion of the adhesive layer being provided between the resist coating and the outboard surface of the wheel.

### BRIEF DESCRIPTION OF DRAWINGS

The present invention will be described with reference to the attached drawings which are given as non-limiting examples only, in which:

FIG. 1 is an example of a resist coating pattern that can be applied to the inboard surface of a wheel cover according to one embodiment of the present invention.

FIG. 2 is an example of a resist coating pattern that can be applied to the inboard surface of a wheel cover according to another embodiment of the present invention.

### WRITTEN DESCRIPTION

The present invention is directed to a method for adhesively securing decorative wheel covers (or “claddings”) to wheels, which method involves the use of resist coatings that prevent plating metals from attaching to the inboard surface of the wheel covers. The method involves applying a resist to the inboard surface of a wheel cover prior to subjecting the wheel cover to a plating process which plates the inboard surface of the wheel cover. The plating process involves a first plating step in which a wheel cover is acid etched and then a small deposit of electroless nickel or copper is applied to the etched substrate which, in the case of plastic wheel covers, makes the wheel cover conductive so that in a subsequent electro-plating process a finish material, or combination of materials, such as chrome can be plated on the inboard surface of the wheel cover (over the under layer).

According to the present invention, the resist prevents the first step of the plating process from plating the under layer material onto selective areas of the inboard surface of the wheel cover. The absence of the under layer material and lack of a corresponding conductive surface subsequently prevents the plating of a smooth, hard and inorganic finish layer on the inboard surface of the wheel cover. As a result, the surface area covered by the resist or areas framed in or outlined by the resist remain susceptible to adhesion by conventional adhesives that are used to secure wheel covers to wheels as opposed to a smooth, hard and inorganic plated finish layer which is not or certainly less susceptible to adhesion by conventional adhesives.

The resist can be applied in various patterns, including patterns that cover the entire inboard surface of a wheel cover. Alternatively, the resist can be applied in discrete solid area patterns. According to one embodiment of the present invention, it has been determined that the resist can be applied so as to frame in or outline areas which are subsequently prevented from being plated. The application of resist in patterns that frame in or outline areas that are desired not to be plated allows for limited use of the resist.

Typically the resist is applied in patterns that correspond to the adhesive pattern that will be applied to secure the wheel cover to a wheel. In this regard, the resist is applied in patterns as discussed above to prevent plating of portions of the inboard surface of a wheel cover where the adhesive pattern subsequently used to secure the wheel cover onto a wheel will be come into contact with the inboard surface of the wheel cover. Generally, any known adhesive pattern can be used, including those taught by the prior art discussed above.

It has been discovered that the resist coating is susceptible to adhesion by conventional adhesives. Therefore, while non-plated areas of the inboard surface of the wheel covers are provided for directed contact with the adhesives used to secure the wheel covers onto wheels, it is also within the scope of the present invention to have at least a portion of the adhesive patterns that are used to secure wheel covers onto wheels cover a portion or all of the resist coating areas as well.

The resist coatings can be applied in any convenient manner including rolling it onto the inboard surface of the wheel, brushing it on, spraying it on, etc. Such applications can be done in either a manual or automated manner.

Resists that can be used according to the present invention include those which have been conventionally applied to flexible plastic parts to prevent such parts from being plated and losing their flexibility. A specific example of a resist used according to the present invention is a resist product that is commercially available from Dhake Industries (Plymouth, Mich.) as SN3KP. In practice, the resist is applied as a resist coating and allowed to cure. The curing can take place at ambient temperatures or elevated temperatures. After curing and plating of any surrounding areas, a conventional adhesive can be applied directly between the cured resist coating and the outboard surface of a wheel to adhesively secure a wheel cover onto the wheel.

Reference is made herein to chrome as providing a smooth, hard and inorganic surface which not conducive for adhesion by conventional adhesives. In practice, chrome plating surfaces typically include under layers of copper, nickel, or alloys thereof, or similar under layer materials.

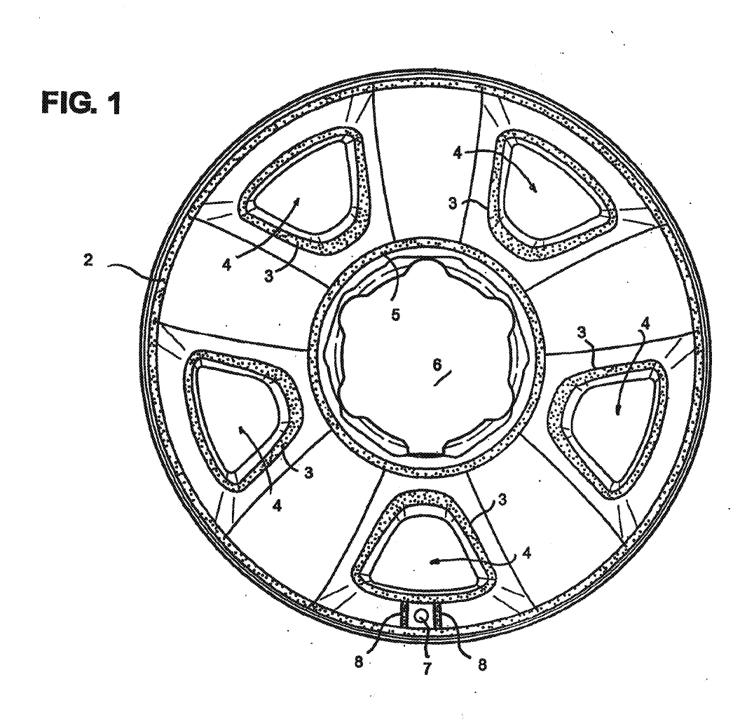

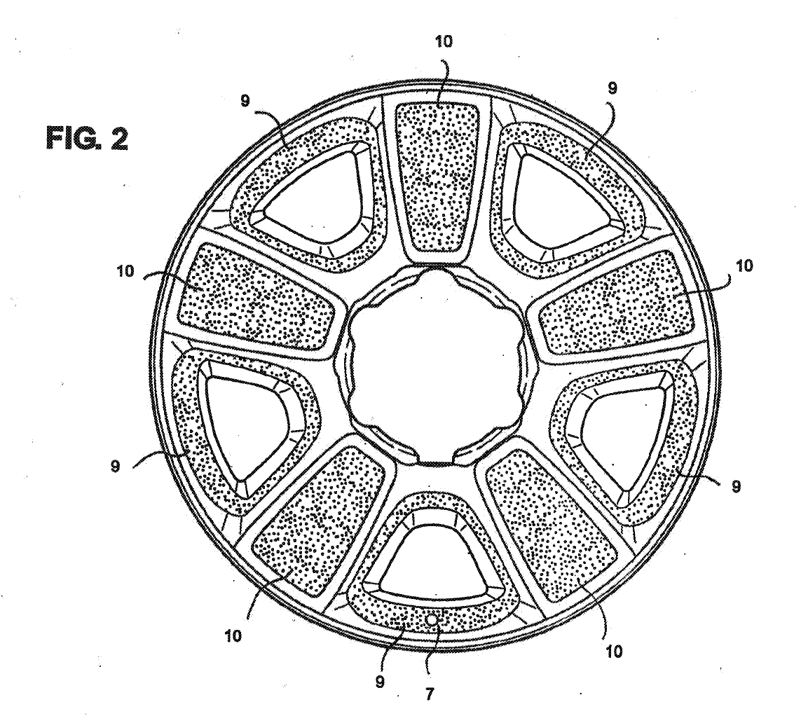

FIG. 1 is an example of a resist coating pattern that can be applied to the inboard surface of a wheel cover according to one embodiment of the present invention. FIG. 1 is an example of the use of a resist coating pattern that frames in or outlines areas of an inboard surface of a wheel cover that are subsequently not plated. In FIG. 1 there is shown a continuous band 2 of a resist material that extends around the outer periphery of the wheel cover 1, and separate continuous bands 3 that extend around the periphery of each opening 4. In addition, there is a continuous band 5 that extends around the central hub 6 area of the wheel cover 1. It is noted that FIGS. 1 and 2 are not to scale, and the resist bands can be relatively thin lines of resist.

When a wheel cover having the resist coating pattern depicted in FIG. 1 is subjected to a plating process the surface area of the wheel cover that extends between the continuous band 2, and separate continuous bands 3 and continuous band 5 will not be plated with under layer material such as copper, nickel, or alloys thereof. As a result, the surface area that extends between the continuous band 2, and separate continuous bands 3 and continuous band 5 will not be conductive and thus will not be plated with a smooth, hard and inorganic material such as chrome.

It is noted that in FIG. 1 the wheel cover 1 includes a valve stem through-hole 7 that is framed in or outlined by resist coating lines 8 that extend between continuous outer peripheral band 2 and band 3 that surrounds an adjunct opening 4. This resist coating pattern prevents the surface area surrounding the valve stem through-hole 7 from being plated in a subsequent plating process.

FIG. 2 is an example of a resist coating pattern that can be applied to the inboard surface of a wheel cover according to another embodiment of the present invention. FIG. 2 is an example of a resist coating pattern that is applied in discrete solid area patterns. In FIG. 2 there are shown separate continuous bands of a resist material 9 that extend around the periphery of each opening 4 of the wheel cover 1 and large areas of a resist material 10 that correspond to the spokes of a wheel.

When a wheel cover having the resist coating pattern depicted in FIG. 2 is subjected to a plating process the surface areas of the wheel cover that are covered by resist coating will not will not be plated with under layer material such as copper, nickel, or alloys thereof. As a result these surface areas will not be conductive and thus will not be plated with a smooth, hard and inorganic material such as chrome.

As can be understood from the description of the present invention, the surface area of the wheel cover in FIG. 1 that extends between the continuous band 2, and separate continuous bands 3 and continuous band 5 will be bare after being subjected to a plating process. In contrast, the surface areas of the wheel cover in FIG. 2 that is provided with the continuous bands of a resist material 9 and large areas of a resist material 10 will remain coated with resist material after being subjected to a plating process.

Accordingly, an adhesive pattern used to secure the wheel cover of FIG. 1 to a wheel will contact bare inboard surface areas of the wheel cover (and possibly adjacent areas that are coated with resist), whereas an adhesive pattern used to secure the wheel cover of FIG. 2 to a wheel will contact resist coated inboard surface areas of the wheel cover.

As can also be understood from the description of the present invention, if the large areas of resist material 10 in FIG. 2 were merely framed in or outlined, the central portions of these areas would not be subsequently plated in a plating process.

FIGS. 1 and 2 are non-limiting examples of resist coating patterns that can be applied to the inboard surface of a wheel cover before subjecting the wheel cover to a plating process which will apply a smooth, hard and inorganic surface, such as chrome, which not susceptible to adhesion by conventional adhesives. Framed in or outlined areas can be used alone, discrete solid areas can be used alone, or any combination of framed in or outlined and discrete areas can be used.

As noted above, the resist can be applied in any convenient manner including rolling it on the inboard surface of the wheel, brushing it on, spraying it on, etc. Further, a mask can be used to apply the resist to the inboard surface of the wheel covers. The mask can be held against the inboard surface of the wheel covers or applied thereto and removed after the resist has been applied in a desired pattern.

The resist coating patterns present after subsequent plating process and/or bare areas of the inboard surface of the wheel cover that were framed in or outlined by resist coating patterns are subsequently used to secure the wheel covers onto the outboard surfaces of wheels by applying suitable adhesives thereto. In this regard, the resist coating patterns can have substantially the same configuration as the subsequent adhesive patterns. Alternatively, the bare areas of the inboard surface of the wheel cover that were framed in or outlined by resist coating patterns can have substantially the same configuration as the subsequent adhesive patterns. Further, the resist coating patterns and/or bare areas can be more extensive than the adhesive patterns that are subsequently used to secure the wheel covers onto the outboard surfaces of wheels in which case the subsequent adhesive patterns can be applied to less than the total surface areas of the resist coating patterns and/or bare areas.

It is to be understood that the method of the present invention can be applied to both plastic and metal wheel covers, with solid areas of resist coating being particularly applicable to metal wheel covers. Further, the adhesive used to subsequently secure the wheel covers onto the outboard surface of wheels can be any type of conventional adhesive, including silicone adhesives, urethane adhesives, epoxy adhesives and polyurethane adhesives, and is not limited to self-foaming adhesives, gas-assisted foamed adhesives, non-foaming adhesives, room temperature curing adhesives, or any type of adhesive.

In addition, it is to be understood that at least a portion of the wheel covers can be attached/secured to the wheel by mechanical means, in addition to the adhesive(s). Exemplary mechanical means can include rim flanges and other conventional mechanical means.

In addition to providing bare inboard surface areas and/or resist coated areas for adhesively securing wheel covers to wheel, the present invention also allows for a reduction of the use of expensive plating metals that are not required to be attached and can be prevented from being attached to the inboard surfaces of a wheel covers. Further, the present invention provides enhanced adhesive strength to secure wheel covers to wheels without the use of adhesive primers.

The following non-limiting examples are being provided to demonstrate features and characteristics of the present invention.

### Examples 1-3

In these examples, three different models or styles of plastic wheel covers were tested. For each different model or style a wheel cover with no resist pattern was attached to a wheel using a foaming adhesive. In addition, for each different model or style wheel covers with two different resist patterns were attached to wheels using the same foaming adhesive. After each wheel assembly was immersed in 70° C. water for 168 hours the wheel covers were pushed of the wheels and the amount of force required to separate the wheel covers from the wheel was measured. The results of these tests are presented in Table 1 below. As identified in Table 1, the resist patterns #1 included continuous resist lines were used to outline only the spoke areas of the wheel covers that were tested. In resist patterns #2 resists patterns similar to that shown in FIG. 1 were used.

TABLE 1
Water immersion Testing on Foam Assemblies
with and without Resist Applied

| Wheel Style | Resist Pattern | Push-Off Force (lbs./f) |
|---|---|---|
| A | None | 35-42 |
| | #1 | 409-486 |
| | #2 | 1786-4570 |
| B | None | 150-153 |
| | #1 | 797-850 |
| | #2 | 4120-4254 |
| C | None | 223-723 |
| | #1 | 961-1092 |
| | #2 | 5620-5810 |

As can be seen from the test results in Table 1, the use of the resist patterns according to the present invention greatly increases the strength by which the wheel covers are adhered to the wheels.

Although the present invention has been described with reference to particular means, materials and embodiments, from the foregoing description one skilled in the art can easily ascertain the essential characteristics of the present invention and various changes and modifications can be made to adapt the various uses and characteristics without departing from the spirit and scope of the present invention as described above and as set forth in the attached claims.

1. A method of securing a wheel cover to a wheel to form a wheel assembly which method comprises:
providing a wheel having an outboard surface;
providing a wheel cover having an inboard surface and an outboard surface;
applying a resist coating pattern to portions of the inboard surface of the wheel cover;
subjecting the wheel cover to a plating process which plates the outboard surface of the wheel cover and which does not plate the portions of the inboard surface of the wheel cover which are:
coated with the resist coating pattern or
framed in or outlined by the resist coating pattern;
applying an adhesive pattern to at least one of the outboard surface of the wheel or the inboard surface of the wheel cover, said adhesive pattern corresponding to at least:
a portion of the resist coating pattern or
an area of the inboard surface of the wheel cover that had been framed in or outlined by the resist coating pattern; and
securing the wheel cover to the wheel with the adhesive pattern.

2. A method of securing a wheel cover to a wheel to form a wheel assembly according to claim 1, wherein the plating process plates the outboard surface of the wheel cover with chrome.

3. A method of securing a wheel cover to a wheel to form a wheel assembly according to claim 1, wherein the adhesive pattern is at least coextensive with the resist coating pattern.

4. A method of securing a wheel cover to a wheel to form a wheel assembly according to claim 3, wherein the adhesive pattern is coextensive with the resist coating pattern.

5. A method of securing a wheel cover to a wheel to form a wheel assembly according to claim 1, wherein the adhesive pattern is less extensive than the resist coating pattern.

6. A method of securing a wheel cover to a wheel to form a wheel assembly according to claim 1, wherein a mask is used to selectively apply the resist coating pattern to the inboard surface of the wheel cover.

7. A method of securing a wheel cover to a wheel to form a wheel assembly according to claim 1, wherein the adhesive pattern comprises substantially the entire inboard surface of the wheel cover.

8. A method of securing a wheel cover to a wheel to form a wheel assembly according to claim 1, wherein the wheel cover is made from a plastic material.

9. A method of securing a wheel cover to a wheel to form a wheel assembly according to claim 1, wherein the wheel cover and wheel include corresponding openings therein that are aligned when the wheel cover is secured to the wheel.

10. A wheel cover for a motor vehicle wheel which comprises:
a disc shaped member having an inboard surface and an outboard surface and which is contoured to be attached to an outboard surface of a vehicle wheel;
a metal plating layer on the outboard surface of the. disc shaped member; and a resist coating pattern on the inboard surface of the disc shaped member.

11. A wheel cover for a motor vehicle according to claim 10, wherein the metal plating layer comprises chrome.

12. A wheel cover for a motor vehicle according to claim 10, wherein the resist pattern covers only a portion of the inboard surface of the disc shaped member.

13. A wheel cover for a motor vehicle according to claim 10, wherein the resist pattern covers substantially the entire inboard surface of the disc shaped member.

14. A wheel cover for a motor vehicle according to claim 10, wherein the disc shaped member is made from a plastic material.

15. A wheel cover for a motor vehicle according to claim 10, further comprising an underlying plating layer other than chrome on the inboard surface of the disc shaped member beneath the resist pattern.

16. A wheel cover for a motor vehicle according to claim 10, wherein the disc shaped member includes a plurality of through-holes therein.

17. A wheel assembly that comprises:
a wheel having an outboard surface;
a wheel cover having an inboard surface and an outboard surface;
a resist coating on a portion of the inboard surface of the wheel cover; and
an adhesive layer securing the inboard surface of the wheel cover against the outboard surface of the wheel with at least a portion of the adhesive layer being provided between the resist coating and the outboard surface of the wheel.

18. A wheel assembly according to claim 17, wherein the outboard surface of the wheel cover has a metallic plating layer thereon.

19. A wheel assembly according to claim 17, wherein the resist coating covers only a portion of the inboard surface of the wheel cover.

20. A wheel assembly according to claim 17, wherein the wheel cover is made of a plastic material.
